(19) United States
(12) Patent Application Publication
(10) Pub. No.: US 2006/0265456 A1
(43) Pub. Date: Nov. 23, 2006

(54) Message authentication system and method

(75) Inventor: Timothy A. Dietrich, Mountain View, CA (US)

Correspondence Address: DLA PIPER RUDNICK GRAY CARY US, LLP, 2000 UNIVERSITY AVENUE, E. PALO ALTO, CA, 94303-2248, US

(73) Assignee: Silicon Storage Technology, Inc.

(21) Appl. No.: 11/134,554

(22) Filed: May 19, 2005

(51) Int. Cl. G06F 15/16

(52) U.S. Cl. 709/206

(57) ABSTRACT

A method for authenticating an electronic message is presented. The method includes embedding a code in an original message in such a way that the code will automatically be a part of a reply message. The method further includes recording the code and a recipient of the original message and, upon receiving the reply message, checking that the code in the reply message matches the code in the original message and that the reply message is from the recipient of the original message. The method is especially useful when used in a secured network that allows tracing the message route to check the recipient. The code may be randomly generated and is preferably difficult to guess. Also presented is a set of computer-readable instructions and systems for executing the method.

### FIELD OF INVENTION

This invention pertains generally to electronic communication and particularly to electronic message exchange over a secured network.

### BACKGROUND

Secure and facile delivery of information is an important goal in the field of electronic communications. Equally important are preservation of confidentiality and integrity of the information that are exchanged. For many individuals, protection of financial and medical information is of paramount importance. As for corporations, they have a strong interest in protecting the confidentiality of information regarding merger discussions, salaries, employee personal information, and any insider information that could affect its stock prices, among others.

One of the ways confidential information can leak is through electronic mail (e-mail) “spoofers” who send messages pretending to be someone else. As spoofers become more sophisticated, it becomes harder for an individual to realize that a message, such as an e-mail, is not from whom the message claims to be. Thus, in responding to spoofer's e-mail, one could inadvertently disclose information to someone who should not be receiving the information, causing an information “leak.”

Another way of obtaining confidential information is via intercepting an email during it's electronic transmission. For example, if a person sends an email over an unsecured wireless network, a hacker could “sniff” or extract that email and information in that email from the network.

FIG. 1 depicts a conventional e-mail system 10 that consists of two servers: a Simple Mail Transfer Protocol (SMTP) server 12 and a (Post Office Protocol) POP3 server 14. The SMTP server 12 handles outgoing mail, and the POP3 server 14 handles incoming mail. In FIG. 2, the SMTP server 12 listens on well-known port number 25 and POP3 listens on port number 110. When a message composer sends an e-mail, the e-mail application on the composer's computer contacts the SMTP server for its network by using Port 25. The SMTP server receives the address of the composer, the address of the intended recipient, and the body of the message. Usually, the SMTP server takes the “to” address and breaks it into the recipient name and the domain name. If the intended recipient is in the same network 10, the SMTP server 22 hands the message to the POP3 server 24 for the proper domain.

FIG. 2 depicts the conventional e-mail system 10 where a message exchange occurs between two different domains. For example, where an e-mail is sent from composer@domainA.com to recipient@domainB.com, the SMTP server for domainA.com first contacts a Domain Name Server (DNS) to obtain the IP addresses for the SMTP server(s) for domainB.com. The SMTP server at domainA.com connects with the SMTP server at domainB.com using port 25 and forwards the message. The domainB's SMTP server recognizes the account called “recipient” and hands the message to domainB's POP3 server, which places the message in the recipient's mailbox. An exemplary conversation between the SMTP server at domainA and the SMTP server at domainB is as follows:

| | |
|---|---|
| SMTP A server: | helo localhost |
| SMTP B server: | 250 mx1.domainB.com Hello |
| SMTP A server: | mail from: composer@domainA.com |
| SMTP B server: | 250 2.1.0 composer@domainA.com . . . Sender ok |
| SMTP A server: | rcpt to: recipient@domainB.com |
| SMTP B server: | 250 2.1.5 recipient@domainB.com . . . Recipient ok |
| SMTP A server: | data |
| SMTP B server: | 354 Enter mail, end with “.” on a line by itself |
| SMTP A server: | from: composer@domainA.com |
| | to: recipient@domainB.com |
| | subject: example email |
| | Body of message |
| | . |
| SMTP B server: | 250 2.0.0 a1NOajJ243l5 Message accepted for |
| | delivery |
| SMTP A server: | quit |
| SMTP B server: | 221 2.0.0 mx1.domainB.com closing connection |
| | Connection closed by foreign host. |

When the recipient at domainB sends a reply message, the SMTP B server contacts the SMTP A server in a similar manner. On an unsecured network, anyone can telnet to the SMTP server machine at port 25 to have one of these dialogs with the SMTP server. This is how an e-mail or a reply message is sometimes “spoofed.” Since the sender's name can be easily spoofed this way, the only way to verify that an e-mail is authentic in this situation is by route tracing. Systems are in place (e.g., spam protection software) that can determine the source of an email, but these systems cannot determine if the email account at that originating SMTP server is valid or not.

Even without intercepting a message by accessing the SMTP server, spoofing can be done by someone who knows or has a reason to believe that a certain message was sent out to a specific person. For example, if a spoofer knows that a certain store sends out emails to all its card holders two Mondays before the weekend of a special event, the spoofer can create a fake reply message thereto. If the SMTP servers are operating over an unsecured network, route tracing or sender validation is impossible or difficult, making this type of spoofing difficult to detect.

A method and system that makes spoofing more difficult is desired for overall protection of confidentiality and integrity in electronic communication.

### SUMMARY

In one aspect, the invention is a method of authenticating an electronic message. The method includes embedding a code in an original message in such a way that the code will automatically be a part of a reply message to the original message. The method further includes recording the code, a composer of the original message, and a recipient of the original message and, upon receiving the reply message, verifying that the reply message includes the code that is embedded in the original message. Optionally, it may also be verified that the code belongs to the sender of the reply message.

In another aspect, the invention is a set of computer-readable medium having computer executable instructions thereon for a method of authenticating an electronic message. The method includes embedding a code in an original message such that the code will automatically be embedded in a reply message, and recording the code, a composer of the original message, and a recipient of the original message. The method also includes verifying that the reply message includes the code that is embedded in the original message. Optionally, it may also be verified that the code belongs to the sender of the reply message.

In yet another aspect, the invention is a system for authenticating electronically exchanged messages. The system includes a composer's computer and a recipient's computer that are exchanging messages. The composer's computer is for embedding a code in an original message upon creation of the original message, recording the code and recipient of the code, and sending the original message to the recipient. The recipient's computer is for receiving the original message with the code and embedding the code in a reply message to the original message before sending the reply message to the composer's computer. The composer's computer, upon receiving the reply message, verifies that the reply message includes the code that is embedded in the original message.

An alternative system includes a composer's computer, a system computer, and a recipient's computer. The composer's computer is for creating an original message intended for a recipient. The system computer is for receiving the original message, embedding a code in the original message, and forwarding the original message to a recipient's computer such that the recipient's computer automatically embeds the code in a reply message to the original message. The system computer is also for forwarding the reply message from the recipient's computer to the composer's computer only if the reply message includes the code embedded in the original message. A database is connected to the system computer for storing the code and a recipient of the original message, and for verifying that the reply message includes the code that is stored. Optionally, it may also be verified that the code belongs to the sender of the reply message.

### BRIEF DESCRIPTION OF THE DRAWINGS

FIG. 1 depicts a conventional e-mail system.

FIG. 2 depicts the conventional e-mail system where a message exchange occurs between two different domains.

FIG. 3 shows a secured network including a system computer and a plurality of clients.

FIG. 4 shows a table that may be used by the database to keep track of the information.

FIG. 5 illustrates one embodiment of the code-based authentication process in the form of a flowchart.

FIG. 6 shows a secured network including a plurality of clients with local databases.

FIG. 7 illustrates another embodiment of the code-based authentication process in the form of a flowchart.

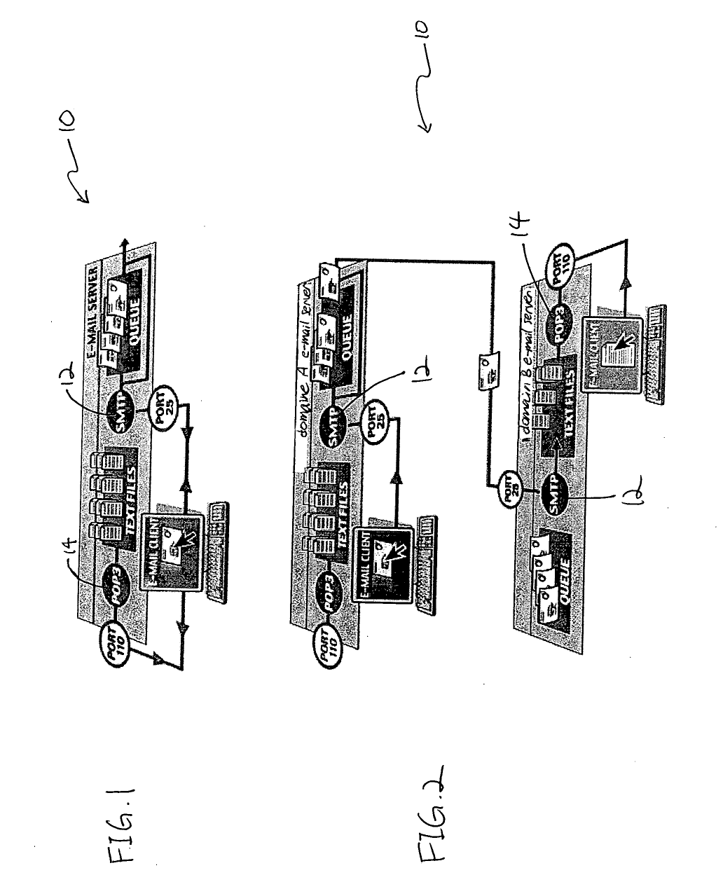

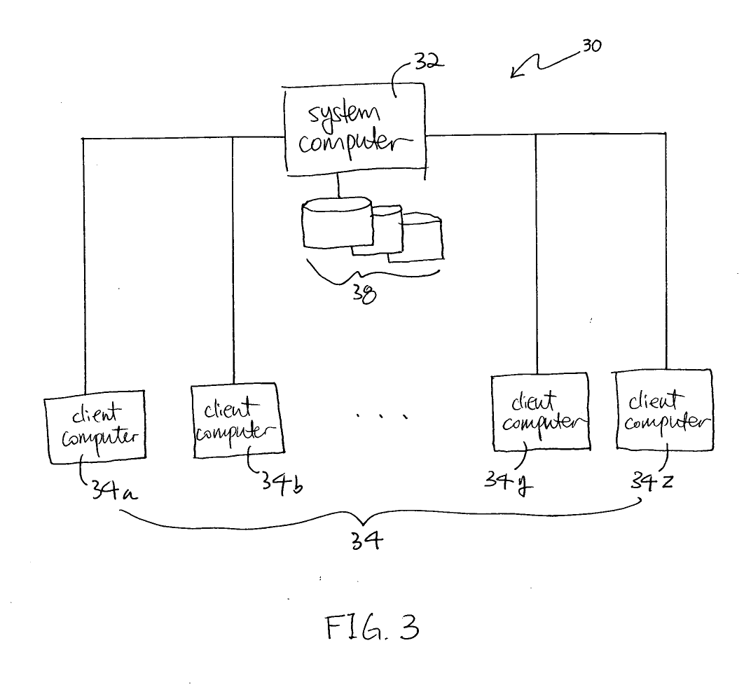

### DETAILED DESCRIPTION OF THE PREFERRED EMBODIMENT(S)

Embodiments of the invention are described herein in the context of an e-mail exchange system. However, it is to be understood that the embodiments provided herein are just preferred embodiments, and the scope of the invention is not limited to the applications or the embodiments disclosed herein.

The message authentication system and method of the invention provides a cost-effective and convenient way of authenticating messages (e.g., e-mails) exchanged within a secured network. The message authentication system verifies whether the sender of the message is indeed the individual whom the message claims to be the sender. If the sender identity is not verified, the message may be returned to the sender and never delivered to the destination, or delivered with a notice to the recipient saying that the sender identity is not verifiable.

An e-mail has a header and a body. A header has multiple fields. As used herein, a “header” includes a From field (i.e., the name of the sender) and a To field (the intended recipient(s)). The header may also include a Subject field, a Date field, a Time field, a Message Size field, an Attachment field, Mime-Version, Content-Type, Sender SMTP server information, etc., depending on the embodiment. The body of the e-mail contains the message created by the sender for the intended recipient.

FIG. 3 shows a secured network 30 including a system computer 32 (e.g., a combination of an SMTP server and a POP3 server) and a plurality of clients 34. Depending on the network, there may be other components that are integrated into the network 30. The system computer 32, which runs on a computer connected to the network 30, contains a list of e-mail accounts, one for each of the clients 34. Each of the clients 34 is an e-mail account that runs on an application on a computer, and is usually associated with a distinct login name (or user name). The individual clients 34a, 34b, . . . are herein collectively referred to as clients 34. A message created by a first client 34a for a second client 34b travels to the system computer 32, which appends the message to the correct address for the second client 34b based on the intended recipient indicated in the header of the message. When the second client 34b is ready to receive its messages (e.g., by turning on the computer and opening the e-mail application), the system computer 32 forwards the messages that are intended for the second client 34b to the second client 34b, sometimes as one large file. The second client 34b downloads the file locally and parses the file into separate messages, each with their own unique headers. The multiple messages are then displayed.

In accordance with the invention, the system computer 32 generates a hash code and attaches it to any new e-mail it receives. Preferably, the hash code is attached to the header of the e-mail, for example to the From field. Thus, if composer@domain.com sends an e-mail and the e-mail reaches the system computer 32, the information in the From field can be composer@domain.com [mM1Kz8KQXUbGFVNyJum1PgIUjyWaDCDve985Po4Y], [mM1Kz8KQXUbGFVNyJum1PgIUjyWaDCDve985Po4Y] being the hash code that the system computer 32 generated and attached. Each newly composed e-mail is associated with a unique and individual hash code. Each hash code may be (but does not have to be) a randomly generated string of 40 alphanumeric characters or more (40 characters would result in 4.9×10⁷¹ combinations of numbers and letters). Although the invention is not limited to a specific length or type of hash code, it is important that the hash code is something that is not easily guessed by potential spoofers. The greater the number of characters in the code, the more difficult it is to determine that code. Preferably, each hash code is separately generated by the system computer 32.

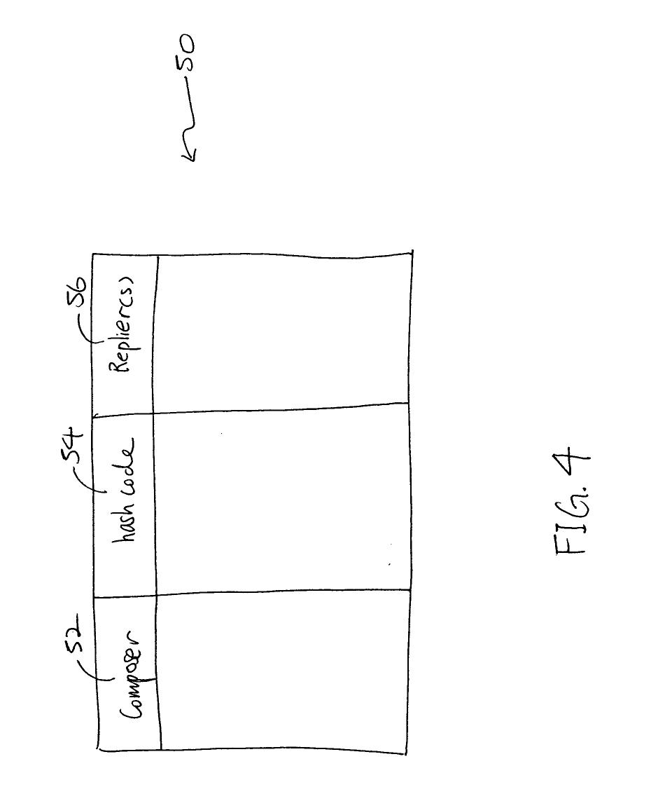

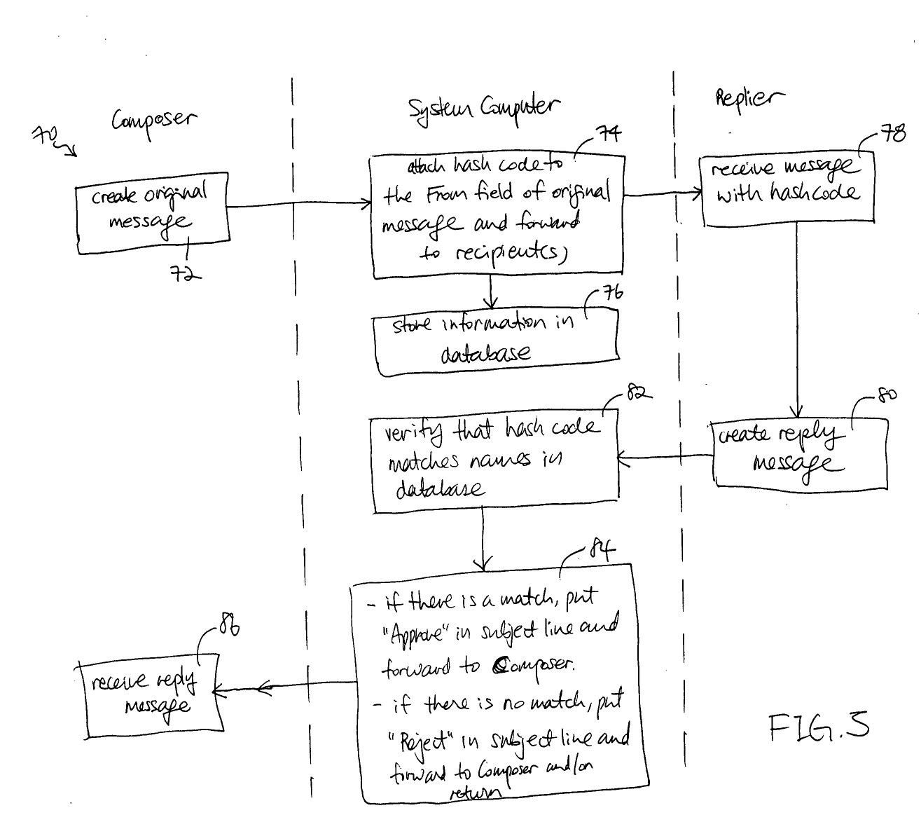

The system computer 32 has access to a database 38, which stores the information regarding a Composer identity, the hash code that is associated with the particular Composer, and the intended recipient for the e-mail created by the Composer. FIG. 4 shows a table 50 that may be used by the database 38 to keep track of the information. The table 50 may have rows indexed by the original messages that are received by the system computer 32. Each row of the table 50 applies to a separate message record. A first column 52 stores the identities of the composer (i.e., the information in the From field), a second column 54 stores the hash code that is associated with the composer for the particular e-mail, and a third column 56 stores the identities of the intended recipient(s) (i.e., the information in the To field). Where multiple messages are composed by the same composer, each of the messages gets a unique hash code. Any reply messages are then associated with a particular row of table 50 based on what the original message was, and the column values are checked. Preferably, the data in all the columns have to match for successful authentication.

When the second client 34b receives the message and responds by using the Reply or the Reply All button, the hash code is included in the To field. When the system computer 32 receives the reply message, it verifies that the hash code, the recipient (which is now the replier), and the composer (which is now the recipient) all match the records in the database 38. This way, every Reply message will be authenticated as being from the client to whom the original message was sent.

FIG. 5 illustrates one embodiment of the code-based authentication process in the form of a flowchart. This embodiment of the code-based authentication process may be implemented with a system such as the one depicted in FIG. 3. An authentication process 70 starts when a Composer creates a message and sends it (step 72). The system computer 32 receives the message, generates a hash code, and attaches it to the From field (step 74). The message with the hash code is then forwarded to the Replier and selective information is stored in the database 38 (step 76). The Replier receives the message (step 78), and replies at his convenience (step 80). When the reply message is created, the hash code in the header of the incoming message is automatically inserted into the header (e.g., the To field) of the outgoing message. The reply message reaches the system computer 32, which verifies the hash code in the header against the information in the database 38 (step 82).

The system computer 32 extracts the code from the reply message header (e.g., the To field) and matches the code to the recorded recipient (e.g., the system extracts the user's email address from the From field) in the database. If the hash code were originally in the From field, the exact same hash code will be in the To field for successful authentication. If there is a match, the system computer 32 inserts an indication in the message to let the Composer know that the message is authenticated. For example, the system computer 32 may insert the word “Approved” in the Subject field (step 84). On the other hand, if not all the fields in the reply message match the information in the database 38, a notice is inserted (e.g., in the Subject field) to let the Composer know that the e-mail is not authenticated (step 84). In some embodiments, the route of the reply message is also verified as a second layer of authentication. An unauthenticated reply message may be returned to the sender of the message, perhaps with a notice saying that the message could not be authenticated. Where the reply message is forwarded to the Composer, the Composer receives the reply message (step 86).

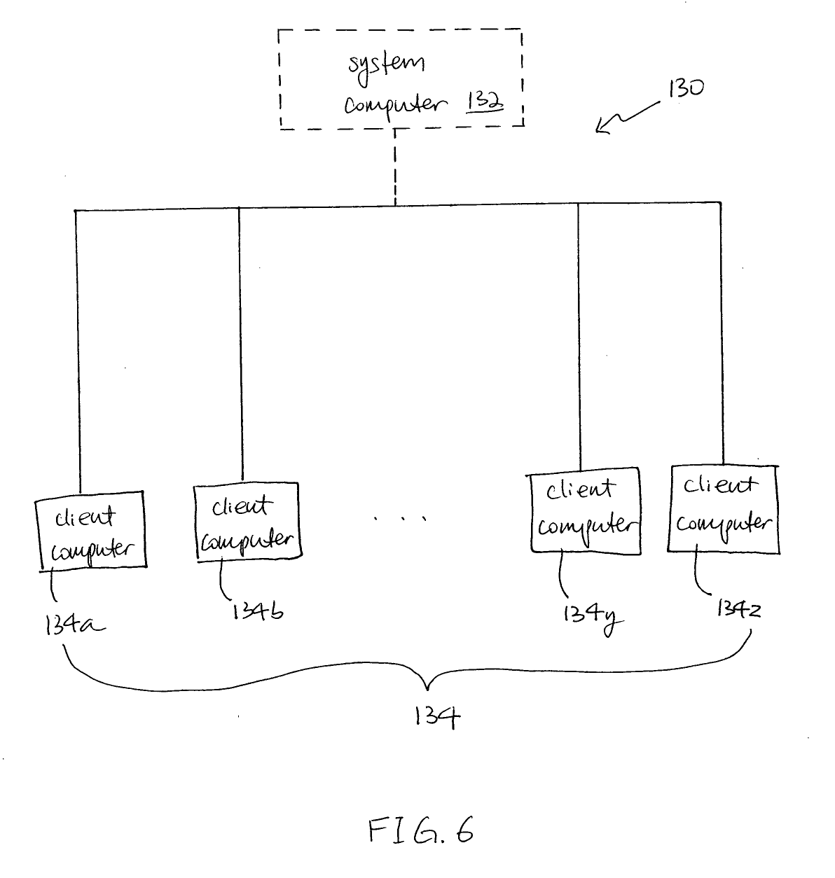

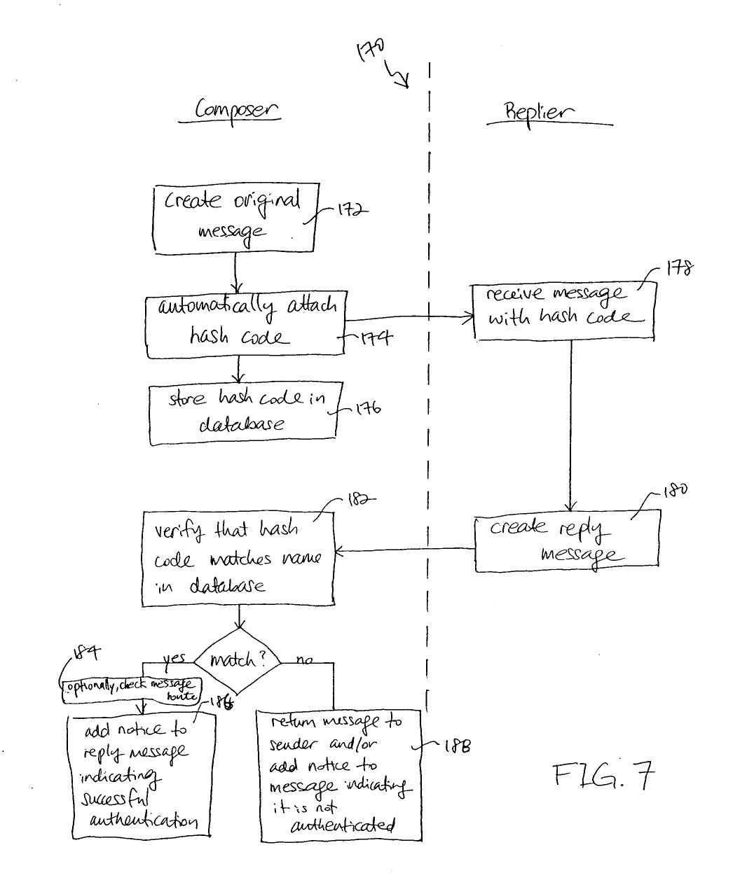

FIG. 6 shows a secured network 130 including a system computer 132 (e.g., a combination of an SMTP server and a POP3 server) and a plurality of clients 134. Unlike in the system of FIG. 3, each of the clients 134 has a local database 138. Each of the clients 134 is an e-mail account that runs on an e-mail application, and the local database 138 is managed by the individual one of the clients 134 to which it is connected. While the code-based authentication capabilities primarily resided with the system computer in the system of FIG. 3, such capabilities reside with the clients 134 in this embodiment and the system computer 132 may be a conventional e-mail server. This embodiment may also be useful where there is no system computer 132 and two or more clients 134 are allowed to exchange messages directly. Clients 134a, 134b, etc. are herein collectively referred to as clients 134.

When a message is created by a first client 134a, the e-mail software of the first client 134a generates and attaches a hash code to the created e-mail. Preferably, the hash code is embedded in the From field. The hash code and the intended recipient(s) of the message are then recorded in the local database 138a and the message with the hash code is sent to a second client 134b (the intended recipient). If the second client 134b creates a reply message, the e-mail software of the second client 134b automatically embeds the received hash code in the To field. When the reply message reaches the first client 134a, the software of the first client 134a automatically checks the header information of the received message against the record in the local database 138a. If the From field of the reply message matches the intended recipient recorded for the hash code that is in the To field, then a notice (a mark, a word, color-coding etc.) is added to the e-mail reply message to let the reader know that the message is authenticated. On the other hand, if there is no match, a different notice may be added to the reply message to let the reader know that the message has not been authenticated.

FIG. 7 illustrates the code-based authentication process of FIG. 6 in the form of a flowchart. The authentication process 170 starts when a Composer creates a message (step 172). When the message is created, the software in the Composer's computer generates a hash code and embeds it in the created message prior to transmitting the message to the intended recipient(s) including a Replier (step 174). The Composer's computer stores the information in the local database (step 176). The Replier receives the message with the hash code (step 178) and creates a reply message (step 180). When the reply message is received by the Composer's computer, the Composer's computer extracts the hash code from the received message and finds the matching hash code in the local database (step 182). If other information associated with the hash code match, optionally, the route of the reply message is verified to ensure that the reply message is indeed from whom it is claimed to be (step 184). Upon successful authentication, a notice could be added to the message to inform the reader that the message has been authenticated (step 186). Alternatively, upon successful authentication, the system can perform automated tasks that the email, instructions, or stored procedure tied to the record in the database instruct the system to do. For example, a stored procedure may be associated with the particular record that has the hash code such that upon successful authentication, the stored procedure (e.g., granting a salary raise) is executed. On the other hand, if there is no matching hash code in the local database or there is a matching hash code but the information associated with the hash code do not match, a notice is added to indicate to the reader that the message has not been authenticated (step 188).

A spoofer who creates a fake reply e-mail pretending to be Replier will not get his message successfully authenticated because the correct hash code is likely to be missing from the header of the spoofed e-mail. Even if the spoofer successfully puts Replier's e-mail address in the From field, the e-mail will not be authenticated if the authentication requires the matching hash code. The code-based authentication method is especially effective when implemented in a secure network where the route of a message can be traced to the sender. In a secured network, it is harder for a spoofer to intercept the message and figure out the hash code. Furthermore, even if a spoofer somehow successfully figured out the hash code, route tracing will reveal that the sender of the reply message does not match the address in the From field, or that the originating of the email message, in actuality, is not what the header information of the email claims.

The code-based authentication method 70 may be implemented on a secured network that allows the system computer 32 to ping the sender of a message to make sure that the sender's e-mail address matches what is in the message header. This message route verification process may be combined with the authentication method 70 to provide an extra layer of authentication and security.

The code-based authentication method 70 may be useful in the context of a company intranet. Suppose an employee composes a message to his boss asking about his raise. The message goes to the system computer 32 and eventually to the boss. The boss sends a reply telling the employee what his raise will be, and this reply message will be authenticated by the system computer 32 before reaching the employee. Thus, the employee will know that whatever response he receives is indeed from his boss and not someone pretending to be his boss. Another example would be the boss sends a reply with the allocated raise, and the computer automatically makes the change in salary in the payroll system.

Although hash code attachment has been used in the context of electronic exchange, it has not been used for message authentication. A well-known electronic invitation service called Evite®, for example, attaches a hash code to each event so that when someone RSVPs, the server will know which event the RSVP is for by reading the hash code. The hash code, however, is not used for any authentication purpose. Furthermore, a person can RSVP to an Evite® only by accessing an internet web site and the RSVP source cannot be verified.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention. For example, the hash code does not have to be added to the header of a message. The hash code could be added to the body of the message in systems if the original message is attached to the reply message.

What is claimed is:

1. A method of authenticating an electronic message, the method comprising:
embedding a code in an original message in such a way that the code will automatically be a part of a reply message thereto;
recording the code, a composer of the original message, and a recipient of the original message; and
upon receiving the reply message, verifying that the reply message includes the code that is embedded in the original message.

2. The method of claim 1 further comprising verifying that the code belongs to a sender of the reply message.

3. The method of claim 1 further comprising verifying that the reply message is from the recipient of the original message.

4. The method of claim 3, wherein verifying that the reply message is from the recipient comprises tracing a route of the reply message.

5. The method of claim 3 further comprising attaching an alert notice to the reply message if the reply message is not verified to be from the recipient.

6. The method of claim 3 further comprising returning the reply message to a sender of the reply message if the reply message is not verified to be from the recipient.

7. The method of claim 1, wherein each of the original message and the reply message has a header and a body, wherein the code is embedded in the header.

8. The method of claim 7, wherein the header has a From field and a To field, and wherein the code is embedded in the From field in the original message and in the To field in the reply message.

9. The method of claim 8 further comprising verifying that the To field of the original message matches the From field of the reply message.

10. The method of claim 1 further comprising verifying that the reply message is directed to the composer.

11. The method of claim 1, wherein recording the code, the composer, and the recipient comprises storing the code, the composer, and the recipient in a database indexed by original messages.

12. The method of claim 1, wherein the code is an alphanumeric string of at least 40 characters.

13. The method of claim 1 further comprising attaching an alert notice to the reply message if the reply message fails to include the code embedded in the original message.

14. The method of claim 1 further comprising returning the reply message to a sender of the reply message if either the reply message fails to include the code in the original message or the reply message is not verified to be from the recipient.

15. The method of claim 1, wherein the original message and the reply message are exchanged over a secured network.

16. The method of claim 1 further comprising randomly generating the code before the embedding.

17. A computer-readable medium having computer executable instructions thereon for a method of authenticating an electronic message, the method comprising:
embedding a code in an original message in such a way that the code will automatically be a part of a reply message thereto;
recording the code, a composer of the original message, and a recipient of the original message; and
upon receiving the reply message, verifying that the reply message includes the code that is embedded in the original message.

18. The computer-readable medium of claim 17, wherein the method further comprises verifying that the code belongs to a sender of the reply message.

19. The computer-readable medium of claim 17, wherein the method further comprises verifying that the reply message is from the recipient of the original message.

20. The computer-readable medium of claim 17, wherein verifying that the reply message is from the recipient comprises tracing a route of the reply message.

21. The computer-readable medium of claim 20, wherein the method further comprises attaching an alert notice to the reply message if the reply message is not verified to be from the recipient.

22. The computer-readable medium of claim 20, wherein the method further comprises returning the reply message to a sender of the reply message if the reply message is not verified to be from the recipient.

23. The computer-readable medium of claim 17, wherein each of the original message and the reply message has a header and a body, wherein the method further comprises embedding the code in the header.

24. The computer-readable medium of claim 23, wherein the header has a From field and a To field, and wherein the code is embedded in a From field in the header of the original message and in a To field in the header of the reply message.

25. The computer-readable medium of claim 24, wherein the method further comprises verifying that the To field of the original message matches the From field of the reply message.

26. The computer-readable medium of claim 17, wherein the method further comprises verifying that the reply message is directed to the composer.

27. The computer-readable medium of claim 17, wherein recording the code, the composer, and the recipient comprises storing the code, the composer, and the recipient in a database indexed by original messages.

28. The computer-readable medium of claim 17, wherein the code is an alphanumeric string of at least 40 characters.

29. The computer-readable medium of claim 17, wherein the method further comprises attaching an alert notice to the reply message if the reply message fails to include the code embedded in the original message.

30. The computer-readable medium of claim 17, wherein the method further comprises returning the reply message to a sender of the reply message if either the reply message fails to include the code in the original message or the reply message is not verified to be from the recipient.

31. The computer-readable medium of claim 17, wherein the method further comprises instructions to randomly generate the code.

32. A system for authenticating electronically exchanged messages, the system comprising:
a composer's computer for:
embedding a code in an original message upon creation of the original message,
recording the code and recipient of the code, and
sending the original message to the recipient; and
a recipient's computer for:
receiving the original message with the code, and
embedding the code in a reply message to the original message before sending the reply message to the composer's computer,
wherein the composer's computer, upon receiving the reply message, verifies that the reply message includes the code that is embedded in the original message.

33. The system of claim 32, wherein the composer's computer, upon receiving the reply message, verifies that the code belongs to a sender of the reply message.

34. The system of claim 32 further comprising a local database connected to the composer's computer to store the code and the recipient of the code.

35. The system of claim 32, wherein each of the original message and the reply message has a header and a body, and wherein the code is embedded in the header.

36. The system of claim 35, wherein the header has a From field and a To field, and wherein the code is embedded in a From field in the header of the original message and in a To field in the header of the reply message.

37. The system of claim 32, wherein the composer's computer verifies that the reply message is directed to the composer's computer.

38. The system of claim 32, wherein the composer's computer verifies that the code in the reply message matches the recorded code by finding the code in the reply message in a database, and verifying that the reply message is received from the recipient recorded for the code in the database.

39. The system of claim 32, wherein the composer's computer randomly generates the code for each original message.

40. The system of claim 32, wherein the composer's computer adds a notice to the reply message indicating whether the code in the reply message matches the recorded code.

41. The system of claim 32, wherein the composer's computer traces a route of the reply message to verify that the reply message is from the recipient's computer.

42. A system for authenticating electronically exchanged messages, the system comprising:
a composer's computer for creating an original message intended for a recipient,
a system computer for:
receiving the original message,
embedding a code in the original message,
forwarding the original message to a recipient's computer such that the recipient's computer automatically embeds the code in a reply message to the original message, and
forwarding the reply message from the recipient's computer to the composer's computer only if the reply message includes the code embedded in the original message; and
a database connected to the system computer for:
storing the code and the recipient of the original message, and
verifying the code in the reply message against the code that is stored.

43. The system of claim 42, wherein each of the original message and the reply message has a header and a body, and wherein the code is embedded in the header.

44. The system of claim 43, wherein the header has a From field and a To field, and wherein the code is embedded in a From field in the header of the original message and in a To field in the header of the reply message.

45. The system of claim 42, wherein the system computer verifies that the reply message is directed to the composer's computer.

46. The system of claim 42, wherein the system computer verifies that the code in the reply message against the code in the database by finding the code in the reply message in the database, and verifying that the reply message is received from the recipient recorded for the code in the database.

47. The system of claim 42, wherein the system randomly generates the code for each original message.

48. The system of claim 42, wherein the system computer adds a notice to the reply message indicating whether the code in the reply message matches the code in the database.

49. The system of claim 42, wherein the system computer traces a route of the reply message to verify that the reply message is from the recipient's computer.
